(19) United States
(12) Patent Application Publication
(10) Pub. No.: US 2016/0298062 A1
(43) Pub. Date: Oct. 13, 2016

(54) PORTABLE PRODUCT FOR CLEANING STAIN

(71) Applicant: Heung Sik PARK, Seoul (KR)

(72) Inventor: Heung Sik PARK, Seoul (KR)

(21) Appl. No.: 14/729,928

(22) Filed: Jun. 3, 2015

(30) Foreign Application Priority Data
Apr. 8, 2015 (KR) 10-2015-0049640

(51) Int. Cl. C11D 17/04; D06L 1/00

(52) U.S. Cl. CPC C11D 17/046; D06L 1/005

(57) ABSTRACT

The portable product for cleaning stain is composed of a body and a case for receiving and keeping the body and includes: a body including a detergent member formed in a bar shape and a protection cover covering the detergent member; and a barrel-shaped case having a space for receiving the body, composed of a first case member and a second case member, which are connected with each other at a joint that is the center of rotation and are separable at other portions, and being open at a side, in which a first locking projection that presses the portion of the body protruding out of the case is formed at the end of the open side of the case so that the body in the case cannot move longitudinally.

### CROSS-REFERENCE TO RELATED APPLICATION

This application claims the benefit of Korean Application No. 10-2015-0049640, filed on Apr. 8, 2015 with the Korean Intellectual Property Office, the disclosure of which is incorporated herein by reference.

### BACKGROUND OF THE INVENTION

1. Field of the Invention

The present invention relates to a portable product for cleaning stain, and more particularly, to a portable product for cleaning stain that can simply remove stains on clothes, and the like.

2. Description of the Related

In general, when fabric products such as clothes are stained with dirt such as food or ink, the fabric products are washed in order to remove the stains due to the dirt on the fabric products.

However, when a person gets a stain on a fabric product such as clothes outdoors, he/she has to keep acting with the stain before returning home.

A stain on clothes may spoil the image of the person wearing the clothes, so it is preferable to partially wash only the portion with the stain as soon as possible right after staining.

However, when a fabric product is stained with dirt such as food or ink, the dirt permeates deep into the fabric, so the stain is not easily removed even the fabric is partially washed with common soap. Further, if the fabric is scrubbed too much to remove the stain, the fabric product may be damaged.

### PRIOR ART DOCUMENT

### Patent Document

Korean Patent Application Publication No. 10-1997-0703412.

### SUMMARY OF THE INVENTION

An object of the present invention is to provide a portable product for cleaning stain that can effectively remove a stain on a fabric product even outdoors, because it is formed in a set composed of a body sized and shaped to be simply carried and a case for receiving and keeping the body.

According to an aspect of the present invention, a portable product for cleaning stain is composed of a body and a case for receiving and keeping the body and includes: a body including a detergent member formed in a bar shape and a protection cover covering the detergent member; and a barrel-shaped case having a space for receiving the body, composed of a first case member and a second case member, which are connected with each other at a joint that is the center of rotation and are separable at other portions, and being open at a side, in which a first locking projection that presses the portion of the body protruding out of the case is formed at the end of the open side of the case so that the body in the case cannot move longitudinally.

A plurality of ring-shaped second locking projections, which presses the portion of the body inserted in the case to prevent the body from moving longitudinally in the case, may be formed at predetermined distances from each other in the longitudinal direction of the case.

A plurality of straight third locking projections, which presses the portion of the body inserted in the case to prevent the body from moving longitudinally in the case, may be formed in parallel in the longitudinal direction of the case.

One or more grooves may be formed at the portions where the third locking projection and the second locking projection cross each other to form curves on the third locking projections.

A plurality of semicircular sub-pressing projections may be formed on the third locking projections so that the third locking projections intensively press predetermined port ions of the body.

Creases allowing for tearing out the protection cover in predetermined lengths to expose the detergent member in predetermined lengths may be formed on the protection cover of the body.

According to the portable product for cleaning stain, since it is formed in a set composed of a main body sized and shaped to be simply carried and a case for receiving and keeping the body, it is possible to effectively remove a stain on a fabric product even outdoors.

### BRIEF DESCRIPTION OF THE DRAWINGS

FIG. 1 is a view illustrating the entire configuration of a portable product for cleaning stain according to an embodiment of the present invention.

FIG. 2 is a view illustrating a body of the portable product for cleaning stain according to an embodiment of the present invention.

FIG. 3 is a cross-sectional view illustrating the body kept by a case of the portable product for cleaning stain according to an embodiment of the present invention.

FIG. 4 is a view illustrating an example of removing a stain with the portable product for cleaning stain according to an embodiment of the present invention.

### DETAILED DESCRIPTION OF THE PREFERRED EMBODIMENTS

Hereinafter, preferred embodiments of the present invention, are described in detail with reference to the accompanying drawings.

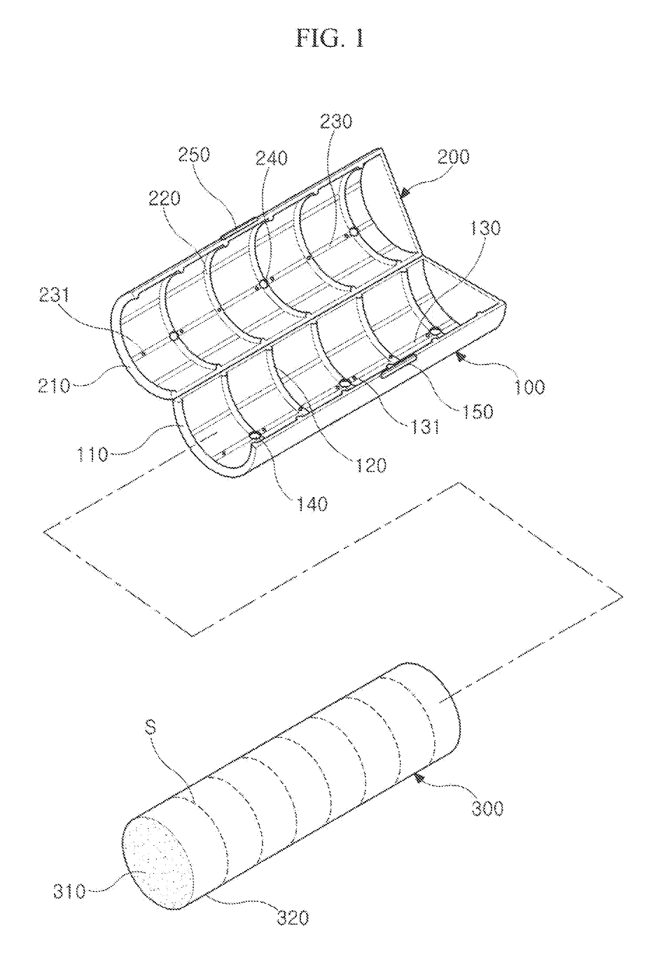

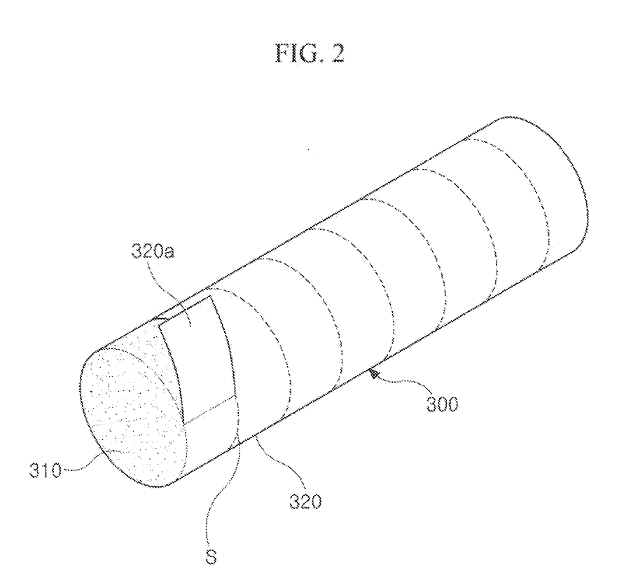

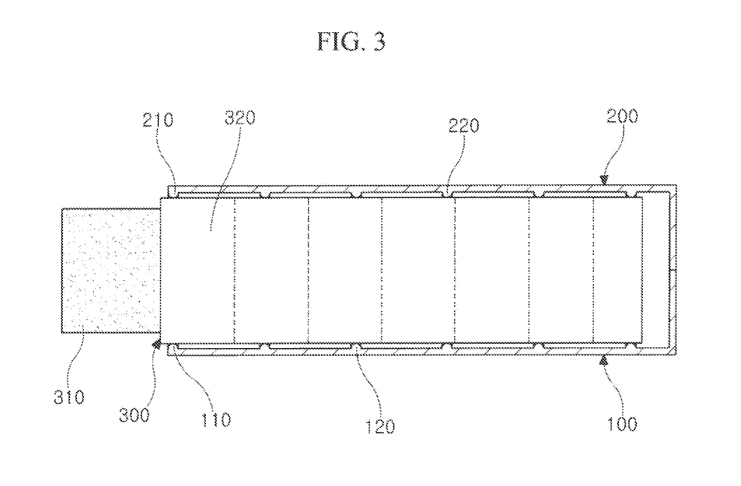

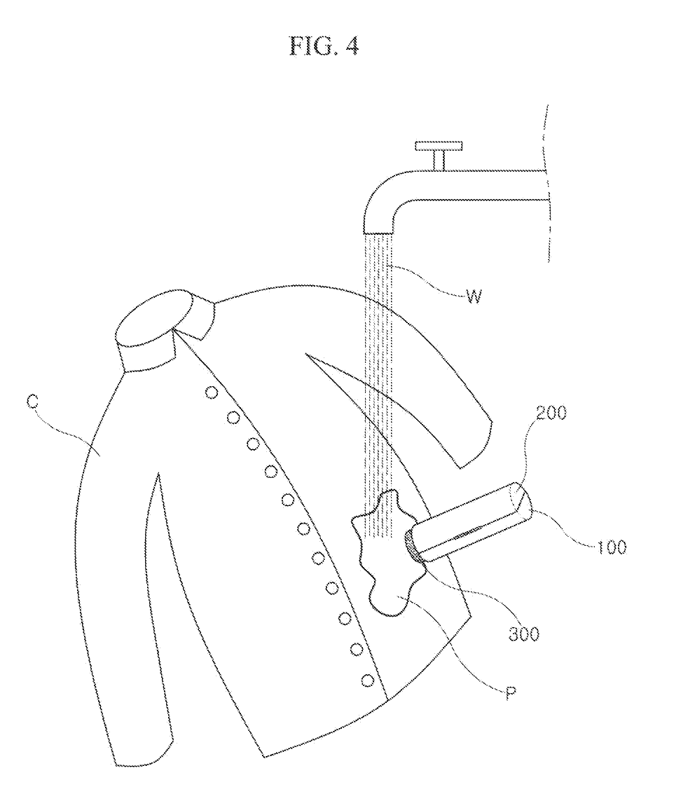

FIG. 1 is a view illustrating the entire configuration of a portable product for cleaning stain according to an embodiment of the present invention, FIG. 2 is a view illustrating a body of the portable product for cleaning stain according to an embodiment of the present invention. FIG. 3 is a cross-sectional view illustrating the body kept by a case of the portable product for cleaning stain according to an embodiment of the present invention, and FIG. 4 is a view illustrating an example of removing a stain with the portable product for cleaning stain according to an embodiment of the present invention.

Referring to FIGS. 1 to 4, a portable product for cleaning stain according to an embodiment of the present invention is composed of a body and a case for body body of the product for cleaning stain.

The portable product for cleaning stain includes a body 300 and a case composed of a first case member 100 and a second case member 200.

The body 300 includes a detergent member 310 for removing stains formed in the shape of a bar and a protection cover 320 covering the detergent member 310.

The body 300 may have a bar shape having various cross-sectional shapes such as a circle, a rectangle, and a triangle, but it is preferable to have the bar shape having a circular cross-sectional as an example in the drawings so that it can be easily received at any position in the case, the protection cover 320 can be simply installed and removed.

The protection cover 320 may be made of thin synthetic resin, paper, paper coated with synthetic resin, or the like.

The protection cover 320 covers the outer side of the detergent member 310 to prevent the detergent member 310 from sticking to a hand of a user. Further, it prevents the detergent member 310 from crumbling, when the body 300 kept in the case is pressed by projections on the case which are described below.

Creases S allowing for tearing out the protection cover 320 in predetermined lengths to expose the detergent member 310 in predetermined lengths are formed on the protection cover 320. Fine holes are formed at regular intervals along the creases S.

Herein, in order to tear out the protection cover 320 in predetermined lengths, as illustrated in FIG. 2, it is possible tear out the protection cover 320 by holding an end 320a of the protection cover and turning it along the creases S.

Meanwhile, the case may be made of various materials, but is preferably made of synthetic resin for convenience in manufacturing and reducing the manufacturing cost.

Further, the case has a space capable of receiving the body 300 and, as illustrated in FIG. 1, is composed of the first case member 100 and the second case member 200, and the hooks 150 and 250 for locking and unlocking are formed on the first case member 100 and the second case member 200, respectively.

Further, the first case member 100 and the second case member 200 are connected at their joint that is the center of rotation and separated at other portions, so when the first case member 100 and the second case member 200 are combined, the case has a barrel shape with a side open.

When the body 300 is formed in the shape of a bar having a circular cross-section, the case has a cylindrical shape with a side open, as illustrated in the figures.

Meanwhile, a first locking projection that presses the portion of the body 300 protruding out of the case is formed at the end of the open side of the case so that the body 300 in the case cannot move longitudinally, as illustrated in FIG. 3.

The first locking projection includes a plurality of first unit projections 110 formed at the first case member 100 and a plurality of second unit projections 210 formed at the second case member 200, and when the first case member 100 and the second case member 200 are combined, the first unit projections 110 and the second unit projections 210 make ring shapes.

On the other hand, a plurality of ring-shaped second locking projections, which presses the portion of the body 300 inserted in the case to prevent the body 300 from moving longitudinally in the case, is formed at predetermined distances from each other in the longitudinal direction of the case.

The second locking projection includes a plurality of first unit projections 120 formed at the first case member 100 and a plurality of second unit projections 220 formed at the second case member 200, and when the first case member 100 and the second case member 200 are combined, the first unit projections 120 and the second unit projections 220 make ring shapes.

On the other hand, a plurality of straight third locking projections, which presses the portion of the body 300 inserted in the case to prevent the body 300 from moving longitudinally in the case, is formed in parallel in the longitudinal direction of the case.

The third locking projections include a plurality of first unit projections 130 formed at the first case member 100 and a plurality of second unit projections 230 formed at the second case member 200.

Meanwhile, it is preferable to form curves on the third locking projections to more strongly hold the body 300, and to this end, it is preferable to form at least one or more grooves at the portions where the third locking projection and the second locking projection cross each other.

The grooves include a plurality of first unit grooves 140 formed at the first case member 100 and a plurality of second unit grooves 240 formed at the second case member 200.

Further, it is preferable to form a plurality of semicircular sub-pressing projections on the third locking projections so that the third locking projections intensively press predetermined portions of the body 300.

The sub-pressing projections include a plurality of first unit sub-pressing projections 131 formed at the first case member 100 and a plurality of second unit sub-pressing projections 231 formed at the second case member 200.

In order to remove a stain on clothes using the portable product for cleaning stain having this configuration according to an embodiment of the present invention, a user can easily and quickly remove a stain P by scrubbing the stain P on a piece of clothing C with the body 300 in received and kept by the first case member 100 and the second case member 200 and then washing it with water W.

According to the portable product for cleaning stain of an embodiment of the present invention, since it is formed in a set composed of a body sized and shaped to be simply carried and a case for receiving and keeping the main body, it is possible to effectively remove a stain on a fabric product even outdoors.

Although specific embodiments of the present invention were described above, it will be understood by those skilled in the art that the present invention may be changed and modified in various ways without departing from the spirit and scope of the present invention described in claims.

What is claimed is

1. A portable product for cleaning stain, which is composed of a body and a case for receiving and keeping the body, the product comprising:
a body including a detergent member formed in a bar shape and a protection cover covering the detergent member; and
a barrel-shaped case having a space for receiving the body, composed of a first case member and a second case member, which are connected with each other at a joint that is the center of rotation and are separable at other portions, and being open at a side,
wherein a first locking projection that presses the portion of the body protruding out of the case is formed at the end of the open side of the case so that the body in the case cannot move longitudinally.

2. The product of claim 1, wherein a plurality of ring-shaped second locking projections, which presses the portion of the body inserted in the case to prevent the body from moving longitudinally in the case, is formed at predetermined distances from each other in the longitudinal direction of the case.

3. The product of claim 2, wherein a plurality of straight third looking projections, which presses the portion of the body inserted in the case to prevent the body from moving longitudinally in the case, is formed in parallel in the longitudinal direction of the case.

4. The product of claim 2, wherein one or more grooves are formed at the portions where the third locking projection and the second looking projection cross each other to form curves on the third locking projections.

5. The product of claim 4, wherein a plurality of semicircular sub-pressing projections is formed on the third locking projections so that the third locking projections intensively press predetermined portions of the body.

6. The product of claim 3, wherein one or more grooves are formed at the portions where the third locking projection and the second locking projection cross each other to form curves on the third locking projections.

7. The product of claim 6, wherein a plurality of semicircular sub-pressing projections is formed on the third locking projections so that the third locking projections intensively press predetermined portions of the body

8. The product of claim 1, wherein creases allowing for tearing out the protection cover in predetermined lengths to expose the detergent member in predetermined lengths are formed on the protection cover of the body.
